(19) United States
(12) Patent Application Publication
(10) Pub. No.: US 2004/0182885 A1
(43) Pub. Date: Sep. 23, 2004

(54) Device for dispensing a medium such as a toothpaste or a gel

(76) Inventors: Ray C. Morrison, New Bedford, MA (US); Gerald A. Sferruzza JR., Lakeville, MA (US)

Correspondence Address: STEVEN N. FOX, ESQ., P.O. BOX 251, CANTON, MA, 02021, US

(21) Appl. No.: 10/394,900

(22) Filed: Mar. 22, 2003

(51) Int. Cl. G01F 11/00

(52) U.S. Cl. 222/181.3; 222/263

(57) ABSTRACT

The invention is a device for use by a person to dispense a medium such as a toothpaste or a gel from a disposable container. The device comprises a pump unit having medium and air pistons engaged with medium and air cylinder portions, respectively, thru a compression stroke and an intake stroke. The device further comprises an intake unit engaged with the pump unit. The intake unit comprises an inlet portion engageable with the container. The intake unit further comprises an intake valve operable from a closed position to an open position where the inlet portion is in communication with the medium cylinder portion. The device further comprises an exhaust unit engaged with the pump unit. The exhaust unit comprises a nozzle portion. The exhaust unit further comprises an exhaust medium valve operable from a closed position to an open position where the medium cylinder portion of the pump unit is in communication with the nozzle portion. The exhaust unit further comprises an exhaust air valve operable from a closed position to an open position where the air cylinder portion of the pump unit is in communication with the nozzle portion. The device further comprises an actuation unit engaged with the pump unit. Activation of the actuation unit causes the medium and air pistons to cycle thru a compression and an intake stroke. At steady state operation, the compression stroke of the medium piston causes a portion of the medium to move thru the exhaust medium valve to the nozzle portion and the compression stroke of the air piston causes a portion of the air contained in the air cylinder portion to expand thru the exhaust air valve to the nozzle portion to dispense a consistent and defined amount of medium. The intake stroke of the medium piston causes a portion of the medium contained in the intake unit to be drawn into the medium cylinder portion of the pump unit. The intake stroke of the air piston causes air to be drawn into the air cylinder portion of the pump unit.

### FIELD OF THE INVENTION

The present invention relates to a device for dispensing a medium such as a toothpaste or gel.

### BACKGROUND OF THE INVENTION

A variety of devices have been developed for use by a person to dispense a medium such as a toothpaste from a disposable container. Such conventional devices have several draw backs. By way of example only, such conventional devices are difficult to clean and may become unsanitary over extended use due to build-up and clogging of the medium. Further, such conventional devices require contact between the dispenser and the surface to which the medium is applied, for example a toothbrush, which may also become unsanitary when one or more people share the same dispenser. Still further, such conventional devices employ one or more mechanisms to roll or squeeze the container to dispense the medium. Conventional devices employing rolling or squeezing mechanisms cannot consistently dispense all of the medium from the container thereby resulting in a significant amount of wasted medium.

### SUMMARY OF THE INVENTION

The present invention is a device for use by a person to dispense a medium such as a paste or a gel from a disposable container in a simple, reliable, and sanitary manner. The device comprises a pump unit having medium and air pistons engaged with medium and air cylinder portions, respectively, thru a compression stroke and an intake stroke. The device further comprises an intake unit engaged with the pump unit. The intake unit comprises an inlet portion engageable with the container and an intake valve operable from a closed position to an open position where the inlet portion is in communication with the medium cylinder portion. The device further comprises an exhaust unit engaged with the pump unit and having a nozzle portion. The exhaust unit further comprises an exhaust medium valve operable from a closed position to an open position where the medium cylinder portion of the pump unit is in communication with the nozzle portion. The exhaust unit further comprises an exhaust air valve operable from a closed position to an open position where the air cylinder portion of the pump unit is in communication with the nozzle portion. The device further comprises an actuation unit engaged with the pump unit. Activation of the actuation unit causes the medium and air pistons to cycle thru a complete compression and intake stroke. At steady state operation, the compression stroke of the medium piston causes a portion of the medium to move thru the exhaust medium valve to the nozzle portion and the compression stroke of the air piston causes the air contained in the air cylinder portion to expand thru the exhaust air valve to the nozzle portion to dispense a substantially consistent amount of medium. The intake stroke of the medium piston causes a portion of the medium contained in the intake unit to be drawn into the medium cylinder portion of the pump unit. The intake stroke of the air piston causes air to be drawn into the air cylinder portion of the pump unit. Upon completion of the intake stroke, the device is ready for subsequent cycles.

### BRIEF DESCRIPTION OF THE DRAWINGS

The following detailed description of the invention will be more fully understood with reference to the accompanying drawings in which:

FIG. 1 is an exploded perspective view of the present invention;

FIG. 2 is a cross-section view of a container having a medium stored therein such as a toothpaste or gel;

FIG. 3 is a rear perspective view of the cover;

FIG. 4 is a front perspective view of the mounting plate;

FIG. 5A is a cross-section perspective view of the pump unit;

FIG. 5B is a rear perspective view of the body portion of the pump unit;

FIGS. 6 and 7 are exploded perspective views of the invention;

FIG. 8 is a perspective view of the intake unit of the invention;

FIG. 9 is a cross-section view of the intake unit of the invention;

FIG. 10 is an exploded perspective view of the exhaust unit of the invention showing the body portion, the exhaust medium valve, the exhaust air valve, the nozzle insert, and the medium channel extending from the exhaust medium valve to the nozzle insert;

FIG. 10A is a perspective view of the exhaust medium valve;

FIG. 10B is a perspective view of the nozzle insert;

FIG. 11 is a top plan view of the body portion of the exhaust unit;

FIG. 12 is a cross-section view taken along line 12-12 of FIG. 11 showing the body portion of the exhaust unit and the air channel extending from the exhaust air valve to the nozzle cavity;

FIG. 13 is a side elevation view of the invention showing the linkage assembly of the actuation unit engaged with the mounting plate of the dispensing unit;

FIGS. 14 and 15 are perspective views showing the linkage assembly engaged with the mounting plate of the dispensing unit;

FIG. 16 is a perspective view of the door control assembly showing the key lock member engaged with the lock rod;

FIG. 16A is an enlarged view of a portion of FIG. 16 showing the teeth of the key lock member engaged with the grooves of the lock rod;

FIG. 17 is a perspective view of the key lock member of the door control assembly of the invention;

FIG. 18 is a cross-section perspective view of the invention showing the device in a closed, normal or retracted state;

FIG. 19 is a cross-section perspective view of the invention showing the state of the device partially thru a compression stroke;

FIG. 20 is a cross-section perspective view of the invention showing the device in a fully open, biased, or compressed state.

FIGS. 21, 22, and 22A are perspective views of a second embodiment of the present invention showing the door control assembly with a cam portion;

FIG. 23 is a perspective view of a third embodiment of the present invention showing a fixed internal and refillable container to store the medium; and

FIG. 24 is a perspective view of a fourth embodiment of the present invention showing the actuation unit having a solenoid.

### DETAILED DESCRIPTION OF THE INVENTION

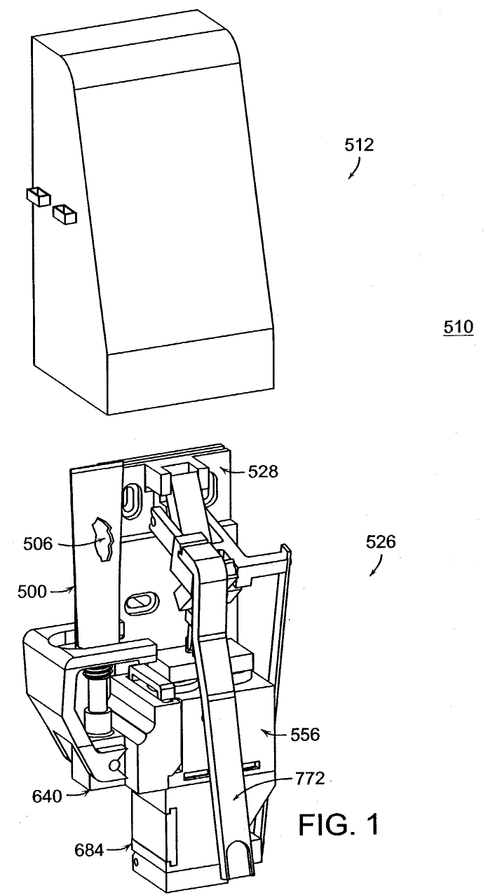

Referring to FIG. 1, a device 510 is shown for dispensing a medium 506 such as a liquid, toothpaste or a gel from a disposable container 500 in a simple, reliable, and sanitary manner. The device 510 generally comprises a dispensing unit 526 and a cover 512. The dispensing unit 526 is a closed system allowing for steady state flow of the medium 506. The dispensing unit 526 generally comprises a mounting plate 528, a pump unit 556, an intake unit 640, an exhaust unit 684, and an actuation unit 772. The mounting plate 528 is generally adapted to securely attach the device 510 to a mounting surface such as a wall (not shown). The pump unit 556 is generally adapted to withdraw medium 506 from the intake unit 640 during an intake stroke (to be described) and to move or extrude the medium 506 to the exhaust unit 684 for dispensing during a compression stroke (to be described). The intake unit 640 is generally adapted to engage with the container 500 to allow withdrawal of the medium 506 to the pump unit 556 during the intake stroke of the pump unit 556. The exhaust unit 684 is generally adapted to dispense or expel a predetermined amount of medium 506 upon completion of the compression stroke of the pump unit 556. The actuation unit 772 is generally adapted to activate and/or otherwise cause the pump unit 556 to cycle through a complete compression stroke and intake stroke. When the device 510 is at steady state operation, completion of the compression stroke of the pump unit 556 causes a portion of the medium 506 to move or extrude to the exhaust unit 684 followed by a volume of compressed air that expands to the exhaust unit 684 to dispense a substantially consistent and defined amount of medium 506. The intake stroke of the pump unit 556 causes a portion of the medium 506 contained in the intake unit 640 to be drawn into the pump unit 556 and a volume of outside air to be drawn into the pump unit 556. Upon completion of the intake stroke, the device 510 is ready for a subsequent cycle by activation of the actuation unit 772.

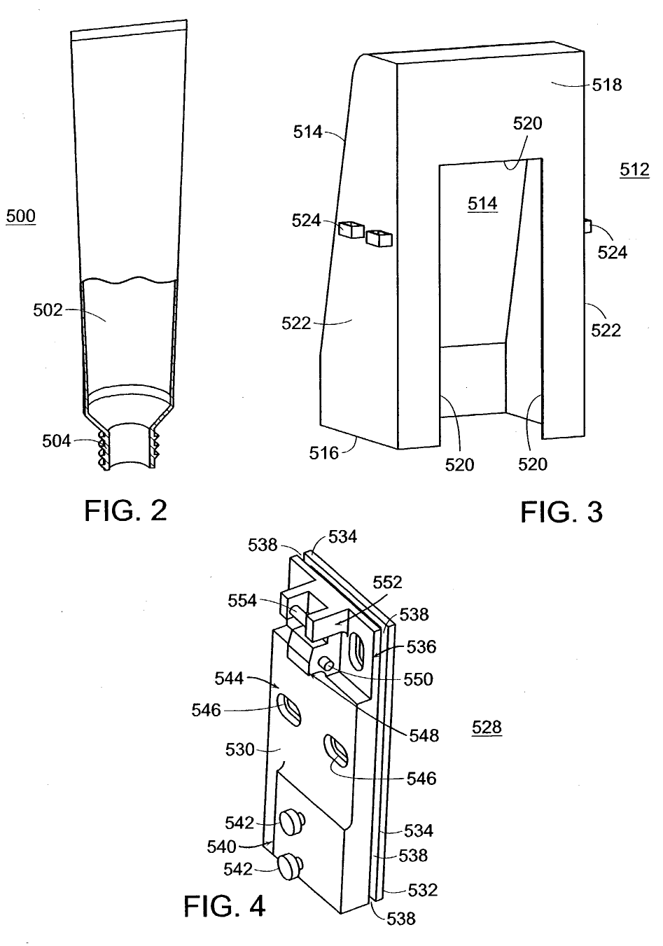

Referring to FIG. 2, the container 500 generally comprises an inner portion 502 adapted to store the medium 506 and an open neck portion 504 to allow the medium 506 to be withdrawn. The container 500 may take a variety of different shapes and sizes. By way of example only, the container 500 may consist of a tube of toothpaste readily available to consumers as an off-the-shelf product. The medium 506 may take a variety of other forms, including hair care and soap products such in the form of a liquid, paste or gel.

Referring to FIG. 3, the cover 512 generally comprises a front wall 514, an open bottom portion 516, a rear wall 518 having a cut-out edge 520, and side walls 522. Cut-out edge 520 is adapted to releasably engage with the cover engagement portion 536 (to be described) of the mounting plate 528. The cover 512 further comprises one or more clips or holders 524 mounted or otherwise formed as part of the side walls 522 and adapted to releasably engage an article such as a toothbrush (not shown). The cover 512 is preferably made of a high strength and durable material that can be sanitized such as high density polyethylene (HDPE). The cover 512 may be made by conventional molding processes.

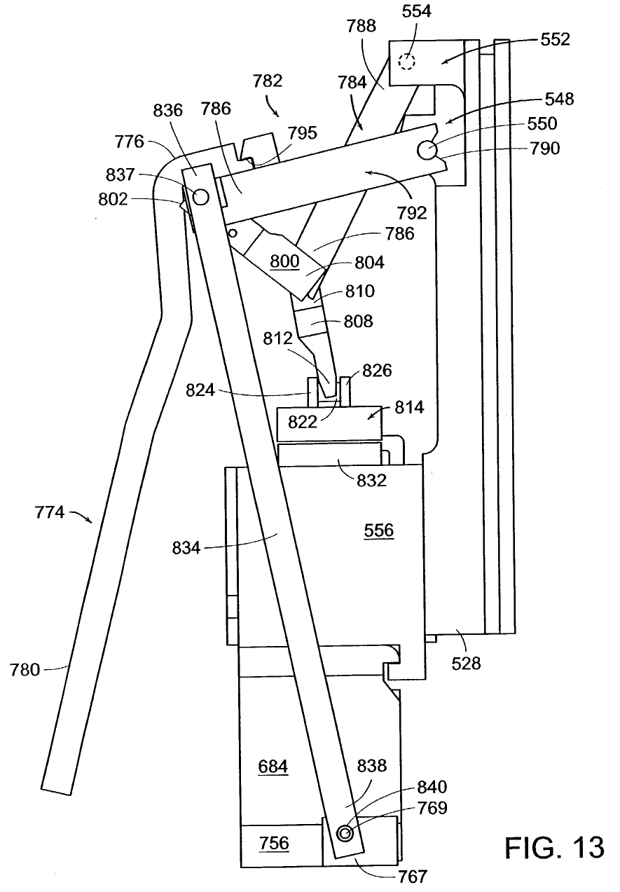

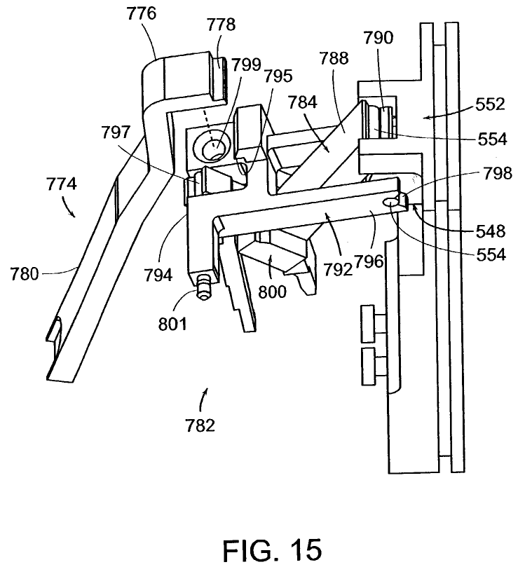

Referring to FIG. 4, the mounting plate 528 generally comprises a front portion 530, a rear portion 532, and edge portions 534. The mounting plate 528 further comprises a cover engagement portion 536 positioned at the edge portions 534, a pump unit engagement portion 540 positioned at the front portion 530, and a surface engagement portion 544. The cover engagement portion 536 is generally adapted to releaseably engage the cover 512 to the mounting plate 528. The cover engagement portion 536 comprises a female fastener such as a recessed channel or groove 538 extending along the edge portion 534 of the mounting plate 528. The groove 538 is adapted to engage with cut-out edge 520 of cover 512. The pump unit engagement portion 540 is generally adapted to securely engage the pump unit 556 to the mounting plate 528. The pump unit engagement portion 540 comprises a plurality of male fasteners such as T-bolts 542. The T-bolts 542 are adapted to engage with a mounting plate engagement portion 580 (to be described) of the pump unit 556 to releaseably secure the pump unit 556 to the mounting plate 528. The surface engagement portion 544 is generally adapted so that the rear portion 532 of the mounting plate 528 is in secure and fixed contact with a mounting surface such as a wall (not shown). The rear portion 532 of the mounting plate 528 is substantially planar to provide secure engagement with the wall (not shown). The surface engagement portion 544 comprises one or more openings 546 adapted to receive a male fastener (not shown) such as a bolt or screw to secure the device 510 to the wall (not shown) or to engage with a fastener mounted to the wall. The mounting plate 528 further comprises an upper link engagement portion 552 having a pin 554 formed or otherwise disposed upon the front portion 530 of the mounting plate 528. The mounting plate 528 further comprises a lever link engagement portion 548 having pins 550 formed or otherwise disposed upon the front portion 530 of the mounting plate 528 and below the upper link engagement portion 552. As shown in FIGS. 13-15, and as will be described more fully herein, the upper link engagement portion 552 of the linkage assembly 782 is adapted to rotatably engage with the upper link 784 of the linkage assembly 782 of the actuation unit 772. The lever link engagement portion 548 is adapted to rotatably engage with the lever link 792 of the linkage assembly 782. The mounting plate 528 is preferably made of a high strength and durable material that can be sanitized such as high density polyethylene (HDPE) or stainless steel. The mounting plate 528 may be made by a conventional machining, casting and/or molding processes.

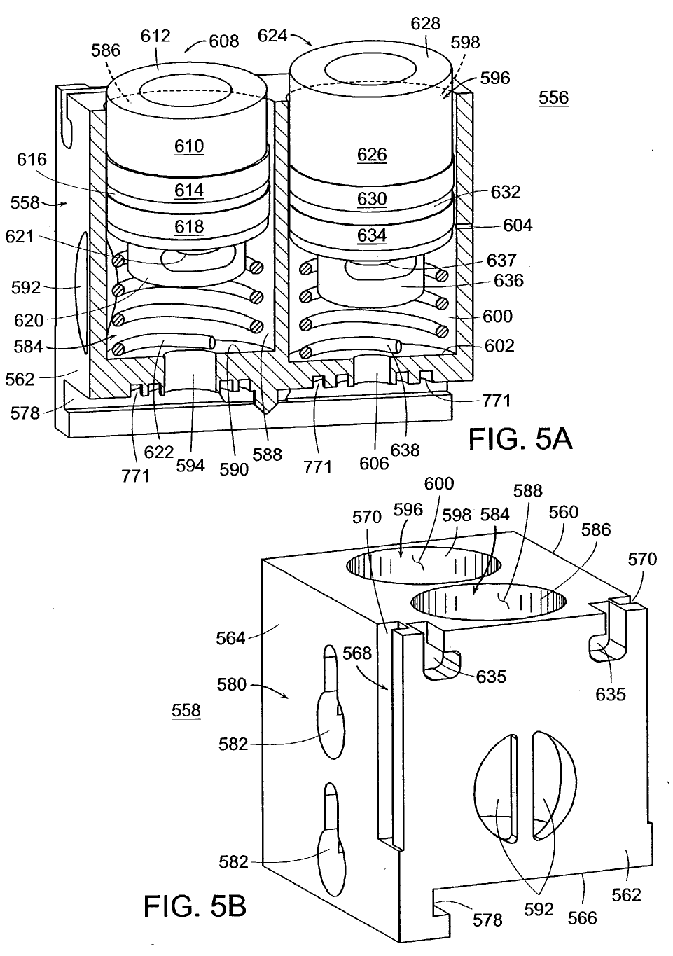

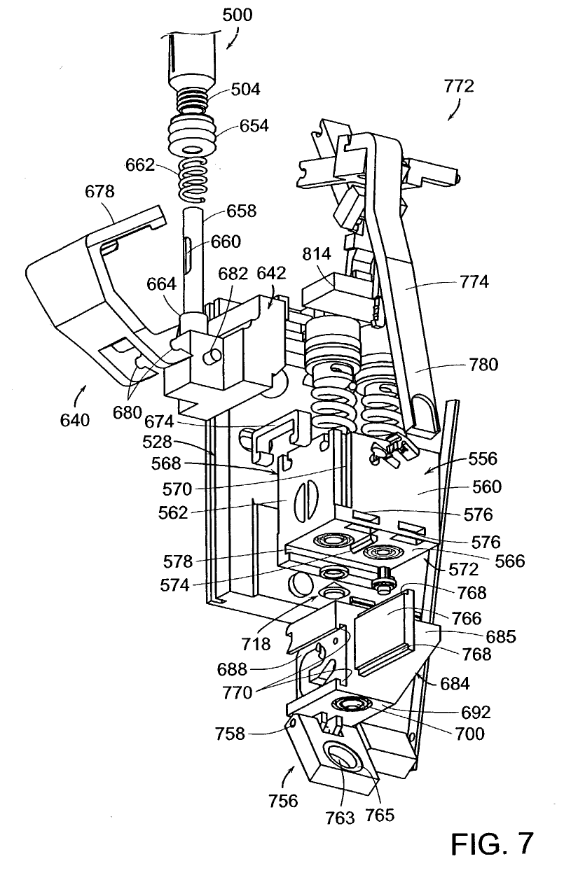

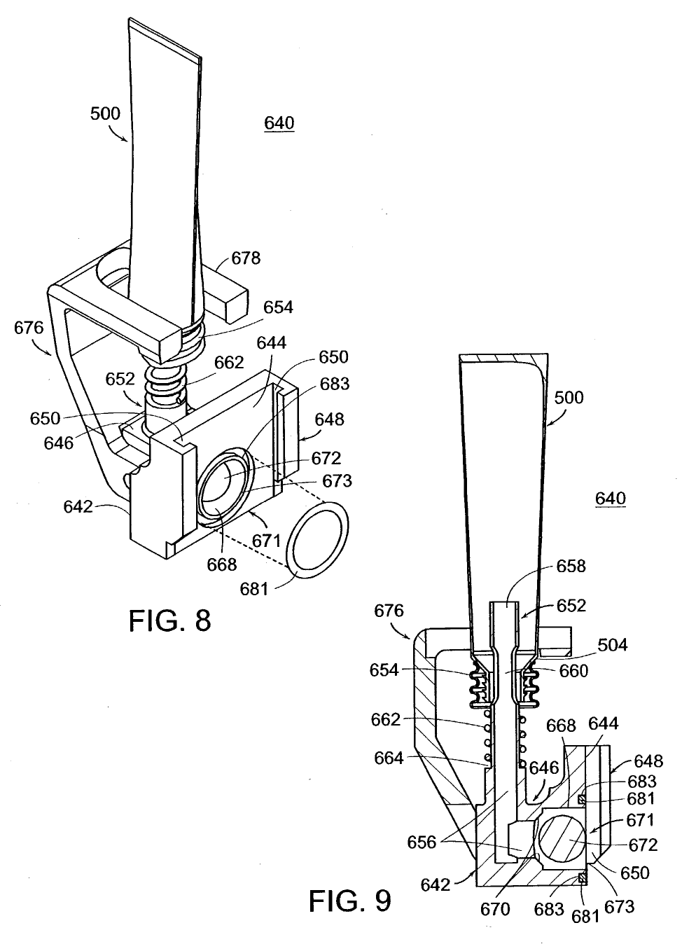

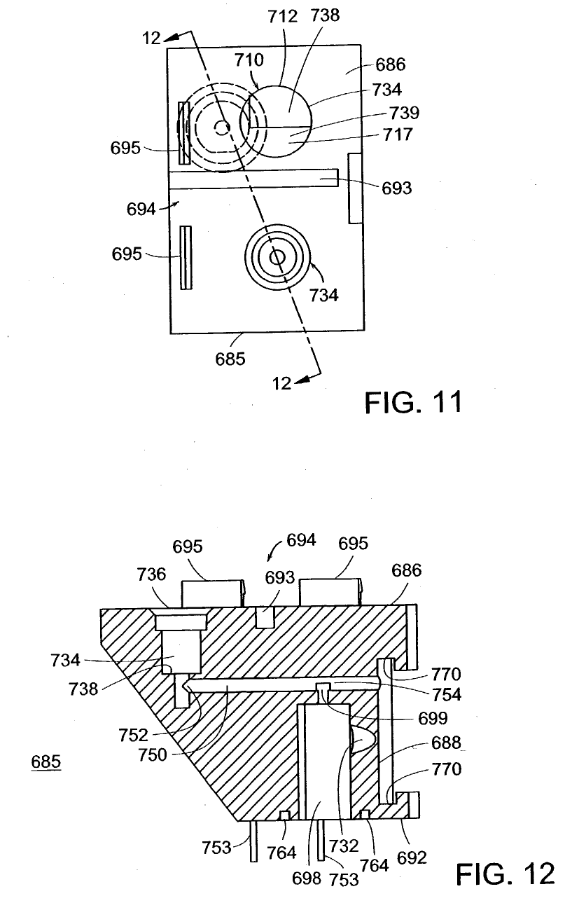

Referring to FIGS. 5A-5B and 6-7, the pump unit 556 comprises a body portion 558 having a front portion 560, a rear portion 564, a side portion 562, and a bottom portion 566. The pump unit 556 further comprises an intake unit engagement portion 568 securely engageable with a pump unit engagement portion 648 shown in FIGS. 8-9 (to be described) of the intake unit 640. The intake unit engagement portion 568 comprises rails 570 disposed about opposite ends of the side portion 562 of the body portion 558. The pump unit 556 further comprises an exhaust unit engagement portion 572 securely engageable with a pump unit engagement portion 694 shown in FIGS. 11-12 (to be described) of the exhaust unit 684. The exhaust unit engagement portion 572 comprises a guide tab 574, a cavity 576, and a channel 578 disposed at opposite ends of the bottom portion 566 of the body portion 558. The pump unit 556 further comprises a mounting plate engagement portion 580 securely engageable with the pump unit engagement portion 540 of the mounting plate 528. The mounting plate engagement portion 580 may comprise a cavity 582 disposed upon the rear portion 564 of the body portion 558 that is adapted to securely receive and engage with the T-bolts 542 of the mounting plate 528. The pump unit 556 further comprises a medium cylinder portion 584 formed as part of the body portion 558. The medium cylinder portion 584 is adapted to sealably engage with a medium piston assembly 608 (to be described) thru a compression stroke and an intake stroke. The medium cylinder portion 584 comprises an open top portion 586, a cylindrical shaped inner wall 588, a floor 590, a medium inlet port 592, and a medium outlet port 594. The medium inlet port 592 is in communication with the intake unit 640 and may take a variety of forms such as an opening or a channel. The medium outlet port 594 is in communication with the exhaust unit 684 and may take a variety of forms such an opening or a channel. The pump unit 556 further comprises an air cylinder portion 596 formed as part of the body portion 558. The air cylinder portion 596 is adapted to sealably engage with an air piston assembly 624 (to be described) thru a compression stroke and an intake stroke. The air cylinder portion 596 comprises an open top portion 598, an inner wall 600, a floor 602, an air inlet port 604, and an air outlet port 606. The air inlet port 604 is in communication with the ambient environment during the intake stroke and sealed by air piston assembly 624 during the compression stroke. The air inlet port 604 and the air outlet port 606 may take a variety of shapes and forms such as an opening or a channel. The pump unit 556 further comprises a medium piston assembly 608 and an air piston assembly 624 adapted to sealably engage with the medium cylinder portion 584 and the air cylinder portion 596, respectively, thru a compression and an intake stroke. The medium piston assembly 608 comprises an upper portion 610 having a top surface 612, a first o-ring 614, a spacer 616, a second o-ring 618, and an end-cap 620 secured together by a fastener 621 such as a snap nut. Similarly, the air piston assembly 624 comprises an upper portion 626 having a top surface 628, a first o-ring 630, a spacer 632, a second o-ring 634, and an end-cap 636 secured together by a fastener 637 such as a snap nut. The pump unit 556 further comprises a medium piston spring 622 disposed within the medium cylinder portion 584. The medium piston spring 622 is normally biased to apply an upward force upon the medium piston assembly 608. The pump unit 556 further comprises an air piston spring 638 disposed within the air cylinder portion 596. The air piston spring 638 is normally biased to apply an upward force upon the air piston assembly 624. The pump unit 556 further comprises a stop member 635 engaged with cavity portions 639 and adapted to limit the upward movement of the medium piston assembly 608 caused by the upward force applied by medium piston spring 622 against the end-cap 620 of the medium piston assembly 608. The pump unit 556 further comprises o-rings 769 mounted within recessed channels 771 and adapted to provide sealed engagement of the pump unit 556 to the exhaust unit 684. The body portion 558 of the pump unit 556 is preferably made of a high strength and durable material that can be sanitized such as high density polyethylene (HDPE). The body portion 558 may be made by conventional molding processes. The medium and air piston assembly 608 and 624 should be made from reliable and durable materials such as plastic and/or stainless steel that can be sanitized. The various components of the medium and air piston assembly 608 and 624 can be purchased as off-the-shelve items. If the medium cylinder portion 584 and air cylinder portion 596 consist of inserts that are mounted within as opposed to formed as part of body portion 558, such inserts are preferably made from a high strength and durable material that can be sanitized such as high density polyethylene (HDPE) and may be manufactured by conventional molding processes.

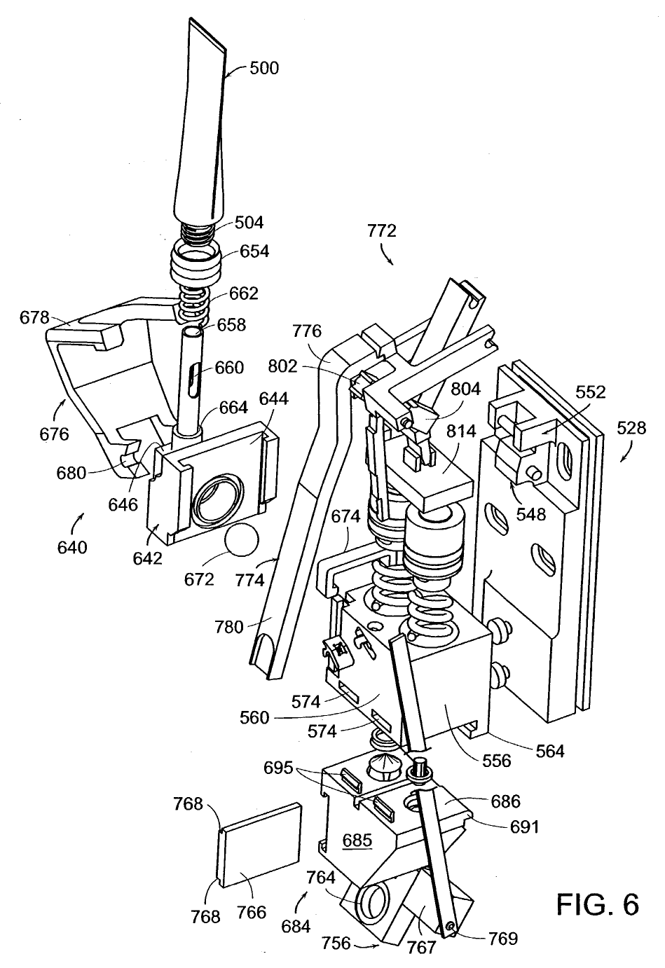

Referring to FIGS. 6-9, the intake unit 640 further comprises a body portion 642 having a side wall 644, a top portion 646, and a pump unit engagement portion 648 disposed on the side wall 644 that is adapted to engage with the intake engagement portion 568 of the pump unit 556. The pump unit engagement portion 648 comprises opposing channels 650 that securely engage with the rails 570 of the pump unit 556. The intake unit 640 further comprises an o-ring 681 mounted within a recessed annular channel 683 and adapted to provide sealed engagement of the intake unit 640 to the pump unit 556. The intake unit 640 further comprises an inlet portion 652 engageable with the container 500 and an outlet portion 671 in communication with the medium cylinder portion 584 upon engagement of the pump unit engagement portion 648 with the intake unit engagement portion 568 of said pump unit 556. The inlet portion 652 comprises a channel 656 extending from an open end portion 658 disposed outward and upward from the top portion 646. The open end portion 658 has an opening 660 to allow increased flow of the medium 506. The inlet portion 652 further comprises a cup seal 654 and a spring 662 mounted on a flange or seat portion 664 that is adapted to urge the cup seal 654 against the neck portion 504 of the container 500. The outlet portion 671 comprises a cavity portion 668 and an open end portion 673. The intake unit 640 further comprises a locking arm 676 adapted to retain the container 500 in place against the upward force applied by the spring 662 and cup seal 654 to the neck portion 504 of the container 500. The locking arm 676 comprises an u-shaped flange 678 spaced above aligned recesses 680 rotatably engaged about a pin 682 formed on the body portion 642 of the intake unit 642. The intake unit 640 further comprises an intake valve 666 disposed in the cavity portion 668. The intake valve 666 is a ball type valve having a ball 672 removably engaged with a seat portion 670. The intake valve 666 is operable from a closed position (where the ball 672 is engaged with the seat portion 670) to an open position (where the ball 672 is not engaged with the seat portion 670) wherein the open end portion 658 of the inlet portion 652 is in communication with the medium cylinder portion 584 of the pump unit 556. The intake unit 640 should be made from a high strength and durable material that can be sanitized such as high density polyethylene (HDPE) and may be manufactured by well known molding and machining processes.

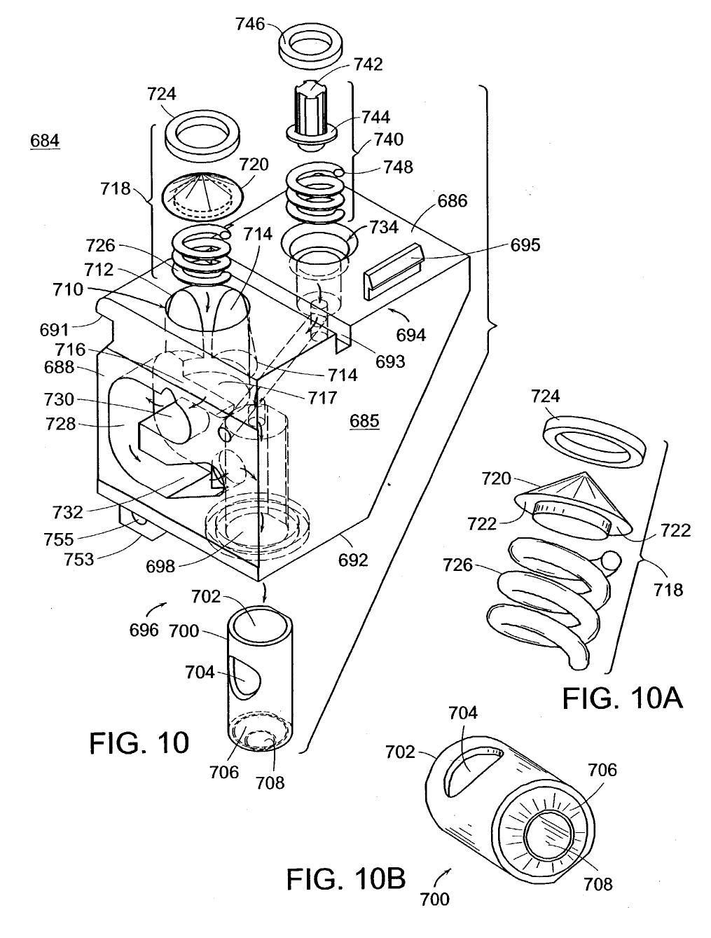

Referring to FIGS. 6-7 and 10-12, the exhaust unit 684 generally comprises a body portion 685 having an upper portion 686, a side portion 688, a bottom portion 692, and a pump unit engagement portion 694 disposed on the upper portion 686. The pump unit engagement portion 694 is adapted to releaseably engage with the exhaust unit engagement portion 572 of the pump unit 556. The pump unit engagement portion 694 comprises a flange 691, guide channel 693 and snap tabs 695 adapted to releasably engage with the channel 578, guide tab 574, and cavities 576, respectively, of the exhaust unit engagement portion 572 of the pump unit 556. The exhaust unit 684 further comprises a nozzle portion 696 having a nozzle cavity 698 formed in the body portion 685 and a nozzle insert 700 adapted to snugly fit within the nozzle cavity 698. The nozzle insert 700 comprises an open top portion 702, an opening 704, a tapered wall 706, and an outlet port 708. The exhaust unit 684 further comprises a medium cavity 710 having an open top portion 712, outwardly tapered walls 714, an open bottom portion 716, and a seat portion 717. The exhaust unit 684 further comprises an exhaust medium valve 718 disposed within the medium cavity 710. The exhaust medium valve 718 is operable from a closed position to an open position where the medium cylinder portion 584 of the pump unit 556 is in communication with the nozzle insert 700 of the nozzle portion 696. The exhaust medium valve 718 may be one-way spring valve generally comprising a tapered upper end portion 720, a flange 722, an o-ring 724, and a spring 726. The o-ring 724 is mounted about the medium outlet port 594 on the bottom portion 566 of the body portion 558 of the pump unit 556. The spring 726 mounts on the seat portion 717 and is biased to urge the exhaust medium valve 718 upward in sealed and closed engagement with the medium outlet port 594 and o-ring 724. The exhaust unit 684 further comprises a medium channel 728 disposed at the side portion 688 of the body portion 685. The medium channel 728 has an upper end portion 730 in communication with the open bottom portion 716 of the medium cavity 710 and a lower end portion 732 in communication with the opening 704 of the nozzle insert 700. The exhaust unit 684 further comprises an air cavity 734 having an open top portion 736, an open bottom portion 738, and a seat portion 739. The exhaust unit 684 further comprises an exhaust air valve 740 disposed within the air cavity 734. The exhaust air valve 740 is operable from a closed position to an open position where the air cylinder portion 596 of the pump unit 556 is in communication with the nozzle insert 700 of the nozzle portion 696. The exhaust air valve 740 may be a pop-off spring valve generally comprising an upper portion 742, a seat portion 744, an o-ring 746, and a spring 748. The o-ring 746 is mounted about the air outlet port 606 on the bottom portion 566 of the body portion 558 of the pump unit 556. The spring 748 mounts on the seat portion 739 and is biased to urge the exhaust medium valve 718 upward in sealed and closed engagement with the air outlet port 606 and o-ring 746. The exhaust unit 684 further comprises an air channel 750 having an upper end portion 752 in communication with the open bottom portion 738 of the air cavity 734 and a lower end portion 754 in communication with both the air inlet 699 of the cavity 698 and the open top portion 702 of the nozzle insert 700. The exhaust unit 684 further comprises a cover 766 having an engagement portion 768 adapted to engage with an engagement portion 770 disposed and formed at the sidewall 688 of the body portion 685 to seal and enclose the medium channel 728. The engagement portion 770 includes upper and lower channels. The exhaust unit 684 further comprises a door 756 rotatably mounted to the bottom portion 692 of the body portion 685 by a plurality of door mounting flanges 753 having openings 755. The door 756 is operable from an open position where medium 506 can be dispensed or expelled to a closed position where the exhaust unit 684 is sealed. The door 756 generally comprises a hinge pin 758 and a torsion spring 760 biased to urge the door 756 closed. The door 756 further comprises a circular cavity portion 763 having a recessed annular channel 765. The door 756 further comprises a door rod mounting portion 767 having a pin 769 adapted to engage with a second end portion 838 of a door rod 834 (to be described). The exhaust unit 684 further comprises a door o-ring 762 disposed within a recessed annular channel 764 mounted about the outlet port 708 of the nozzle insert 700 and on the bottom portion 692 of the body portion 685. The o-ring 762 and recessed cavity 764 are adapted to receive and sealably engage with the outlet port 708 of the nozzle insert 700 when the door 756 is closed. The body portion 685 of the exhaust unit 684 is preferably made of a high strength and durable material that can be sanitized such as high density polyethylene (HDPE). The body portion 685 may be made by conventional molding processes. The exhaust medium valve 718 and its various components may be purchased as off-the-shelf items and assembled by conventional methods and should be made from reliable and durable materials such as plastic and/or stainless steel that can be sanitized. The nozzle insert 700 is made from a high strength and durable material that can be sanitized such as high density polyethylene (HDPE) and may be manufactured by conventional molding processes.

Referring to FIGS. 6-7, and 13-15, the actuation unit 772 generally comprises a lever 774, a linkage assembly 782, and a push block 814. The actuation unit 772 is activated by a person depressing or moving the lever 774 downward which causes the linkage assembly 782 to move the push block 814 downward to impart a compression stroke to the pump unit 556. The lever 774 comprises a lower end portion 780 that may be grasped by the person and an upper end portion 776 having a flange portion 778 and a protrusion 779 adapted to rotatably engage with a first end portion 794 of a lever link 792 (to be described). The linkage assembly 782 further comprises an upper link 784 having first and second end portions 786 and 788. The first end portion 786 comprises a recessed channel 787 adapted to rotatably engage with a pin 806 of a second end portion 804 of a mid link 800 (to be described). The second end portion 788 comprises a recessed channel 790 adapted to rotatably engage with the pin 554 of the upper link engagement portion 552 of the mounting plate 528. The linkage assembly 782 further comprises a lever link 792 having a first end portion 794 and a second end portion 796 having a recessed channel 798 adapted to rotatably engage with the pin 550 of the lever link engagement portion 548 of the mounting plate 528. The upper link engagement portion 552 is disposed above the lever link engagement portion 548. The lever link 792 further comprises a mid link pin 797 mounted at the first end portion 794 and adapted to engage with a first end portion 802 of a mid link 800 (to be described). The lever link 792 further comprises a lever receptacle or opening 799 and a lever channel 795 adapted to receive the protrusion 779 and flange portion 778, respectively, of the upper end portion 776 of the lever 774. The lever link 792 further comprises a door rod pin 801 adapted to receive and engage with a first end portion 836 of a door rod 834 (to be described). The linkage assembly 782 further comprises a mid link 800 having a first end portion 802 having a recessed channel 803 and a second end portion 804 having a pin 806. The recessed channel 803 of the first end portion 802 of the mid link 800 is rotatably engaged with the mid link pin 797 of the lever link 792. The pin 806 of the second end portion 804 of the mid link 800 is adapted to rotatably receive and engage with the recessed channel 787 of the first end portion 786 of the upper link 784 and a first end portion 810 of a lower link 808 (to be described). The linkage assembly 782 further comprises a lower link 808 having first and second end portions 810 and 812. The first end portion 810 comprises a recessed channel 811 adapted to rotatably receive and engage with the pin 806 of the mid link 800. The second end portion 812 comprises a recessed channel 813 adapted to rotatably receive and engage with a pin 822 of a engagement portion 820 of the push block 814 (to be described). The linkage assembly 782 further comprises a push block 814 having a lower portion 816 adapted to engage with directly or indirectly with the medium and air piston assembly 608 and 624 of the pump unit 556, an upper portion 818, and an engagement member 820. The engagement member 820 comprises a pin 822 extending from a first sidewall 824 to a second sidewall 826 mounted on the upper portion 818 of the push block 814. The pin 822 is adapted to receive and engage with the recessed channel 813 of the second end portion 812 of the lower link 808. The push block 814 further comprises an opening 828 to receive an adjustable medium piston spacer 830 (to be described). The medium piston spacer 830 is adapted to moveably and securely engage with the opening 828 of the push block 814 to allow the length of the medium piston spacer 830 to be adjustably extended or retracted as needed to control the travel of the medium piston assembly 608. The linkage assembly 782 further comprises an air piston spacer 832 adapted to control the travel of the air piston assembly 624. The linkage assembly 782 further comprises a door rod 834 having first and second end portion 836 and 838. The first end portion 836 comprises an opening 837 adapted to receive and engage with the door rod pin 801 of the first end portion 794 of the lever link 792. The second end portion 838 comprises an opening 840 adapted to receive and engage with the pin 769 of the door rod mounting portion 767 of the door 756 of the exhaust unit 684. Downward movement of the lever 774 of the linkage assembly 782 causes downward movement of the door rod 834 and the door 756 to completely open at the completion of the compression stroke of the pump unit 556.

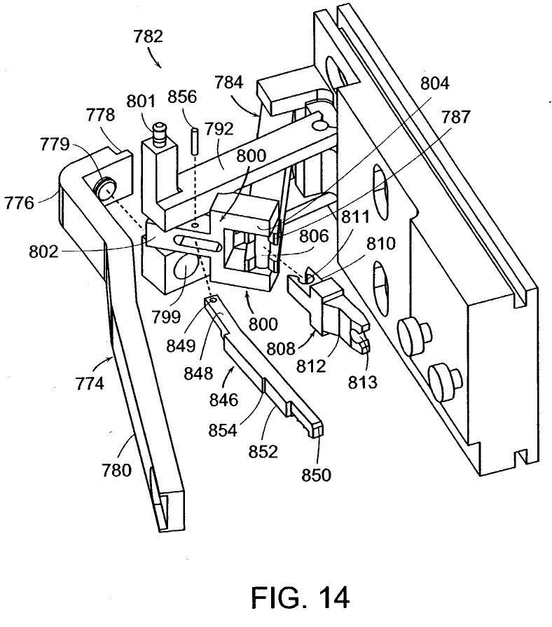

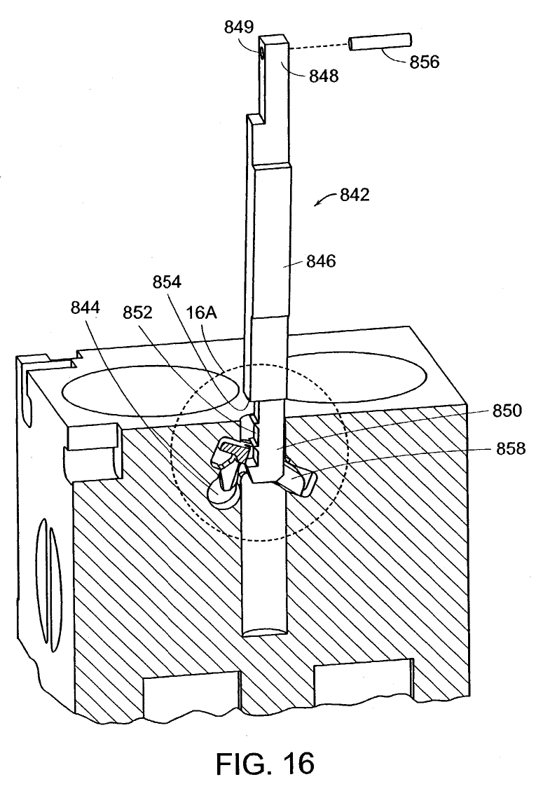

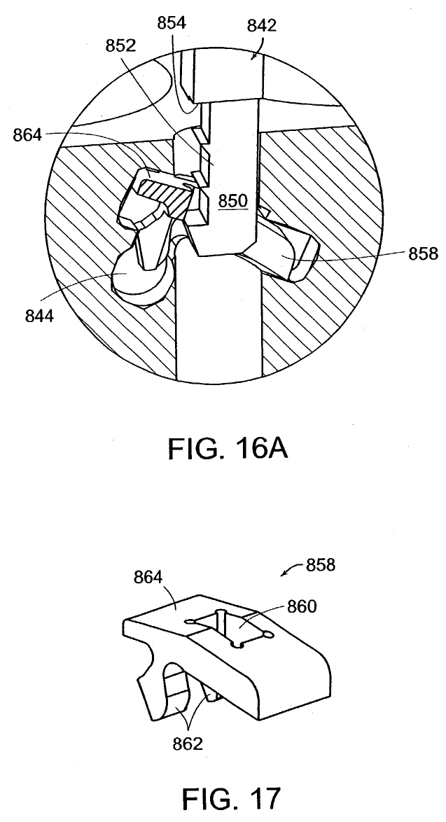

Referring to FIGS. 14 and 16-17, the dispensing unit 526 may further comprise a door control assembly 842 that is adapted to force a complete downward movement of door 756 during a compression stroke of the pump unit 556. The door control assembly 842 generally comprises a key lock cavity 844 formed on the front portion 560 of the body portion 558 of the pump unit 556, a lock rod 846, and a key lock member 858 rotatably moveable within the key lock cavity 844. The lock rod 846 comprises an upper end portion 848 having an opening 849 adapted to receive and rotatably engage with the mid link 800 by a pin 856. The lock rod 846 further comprises a lower end portion 850 and a release portion 854 in the form of a flange portion. The lower end portion 850 has a plurality of grooves 852 for locking engagement with teeth 862 (to be described) of the key lock member 858. The key lock member 858 comprises an opening 860 adapted to allow the lock rod 846 to pass therein, a plurality of downwardly extending teeth 862, and a release portion 864. The teeth 862 are adapted to securely engage with the grooves 852 of the lower end portion 850 of the lock rod 846 to provide for one-way movement of the lock rod 846 during the compression stroke of the pump unit 556. As the lock rod 846 is moved downward (caused by depression of lever 774) through opening 860, the teeth 862 become engaged with the grooves 852 to fix the lock rod 846 from position to position until completion of the compression stroke of the pump unit 556. Concurrent with the end of the compression stroke, the release portion 854 of the lock rod 846 becomes engaged with the release portion 854 of the key lock member 858 whereby the key lock member 858 along with the opening 860 rotate within the key lock cavity 844 to disengage the teeth 862 of key lock member 858 from the grooves 852 of the lock rod 846 which allows the lock rod 846 to retract upward as a result of the upward movement of the biased medium and air piston assembly 608 and 624 during the intake stroke of the pump unit 556.

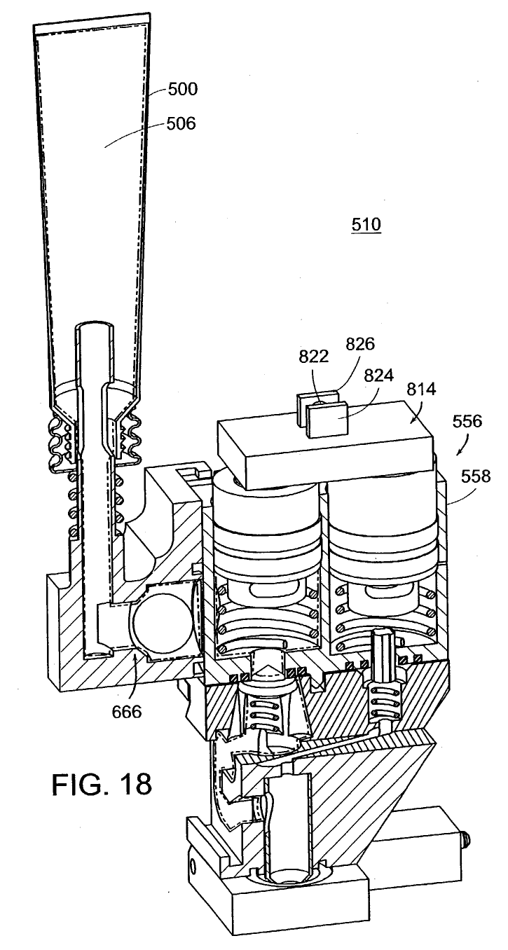

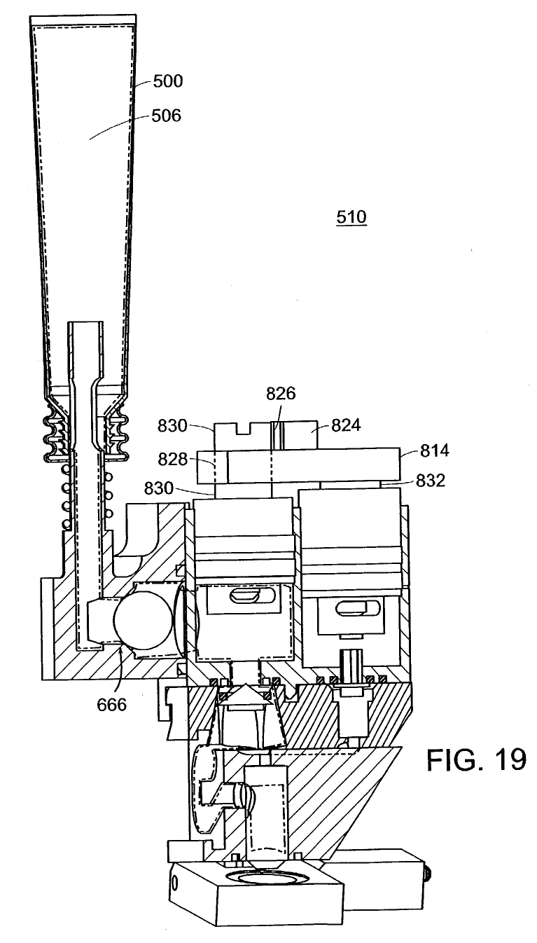

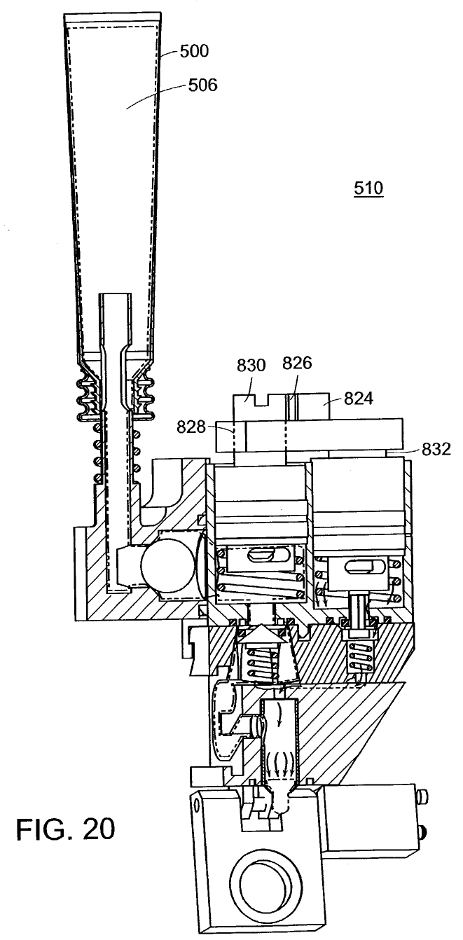

Referring to FIGS. 18-20, the device 510 is a sealed and closed steady state system that provides a reliable and consistent flow or extrusion of the medium 506. The flow boundary of the medium 506 is indicated by a dashed line 508. In FIG. 18, the device 510 is shown in a normally closed and retracted state wherein the intake valve 666 of the intake unit 640 is open and the exhaust medium valve 718 and the exhaust air valve 740 of the exhaust unit 684 are closed. In FIG. 19, the device 510 is shown in a state prior to the completion of a compression stroke wherein the intake valve 666 of the intake unit 640 is closed, the exhaust medium valve 718 of the exhaust unit 684 is open, and the exhaust air valve 740 of the exhaust unit 684 is closed. In FIG. 20, the device 510 is shown in a fully biased and compressed state wherein the intake valve 666 of the intake unit 640 is closed, and both the exhaust medium valve 718 and the exhaust air valve 740 of the exhaust unit 684 are open.

The device 510 is operated as follows: A container 500 filled with medium 506 is engaged with the inlet portion 652 of the intake unit 640 and the locking arm 676 is engaged with and retains the container 500 in sealed contact with the inlet portion 652. Activation of the actuation unit 772 is initiated by manual depression of the lever 774. Manual depression of the lever 774 causes the linkage assembly 782 to move the medium and air piston assembly 608 and 624 thru a complete compression stroke whereby the medium piston spring 622 and the air piston spring 638 become fully biased. During the initial compression stroke of the medium and air piston assembly 608 and 624, the intake valve 666 of the intake unit 640 is closed and there is no medium 506 within the medium cylinder portion 584 to extrude or otherwise move into the exhaust unit 684. Upon completion of the initial compression stroke, the key lock member 858 is caused to rotate to allow the lock rod 846 to be released whereby the fully biased medium and air piston springs 622 and 638 cause the medium and air piston assembly 608 and 624, respectively, to retract or move thru the intake stroke to complete a first cycle. The initial intake stroke of the medium and air piston assembly 608 and 624 creates a vacuum that opens the intake valve 666 of the intake unit 640. The exhaust medium valve 718 and the exhaust air valve 740 of the exhaust unit 684 are closed by the biased force of springs 726 and 748, respectively. The vacuum causes the medium 506 to be withdrawn or extracted from the container 500 into the intake unit 640. The actuation unit 772 may have to be depressed several times or cycles until the device 510 reaches steady state flow. When the device 510 reaches a steady state flow, further activation of the actuation unit 772 causes the medium and air piston assembly 608 and 624 to move thru another compression stroke whereby the medium piston assembly 608 extrudes or otherwise causes a portion of the medium 506 to enter the nozzle portion 696 and air piston assembly 624 causes a portion of the air contained in the air cylinder portion 596 to move thru said exhaust air valve 740 to the nozzle portion 696 wherein a fixed amount of the medium 506 is dispensed from the nozzle portion 696. Air is released into the nozzle portion 696 after the medium 506 to dispense or expel a predefined and consistent amount of medium 506. Upon completion of the compression stroke, the key lock member 858 is caused to rotate to allow the lock rod 846 to be released whereby the medium piston and air springs 622 and 638 cause the medium and air piston assembly 608 and 624, respectively, to retract thru the intake stroke and complete another cycle. The intake stroke of the medium and air piston assembly 608 and 624 cause a vacuum to be created within the medium cylinder portion 584 which opens the intake valve 666 of the intake unit 640. The exhaust medium valve 718 and the exhaust air valve 740 of the exhaust unit 684 are closed by the biased force of springs 726 and 748 thereby allowing the medium 506 to be withdrawn from the container 500 into the intake unit 640 and the pump unit 556.

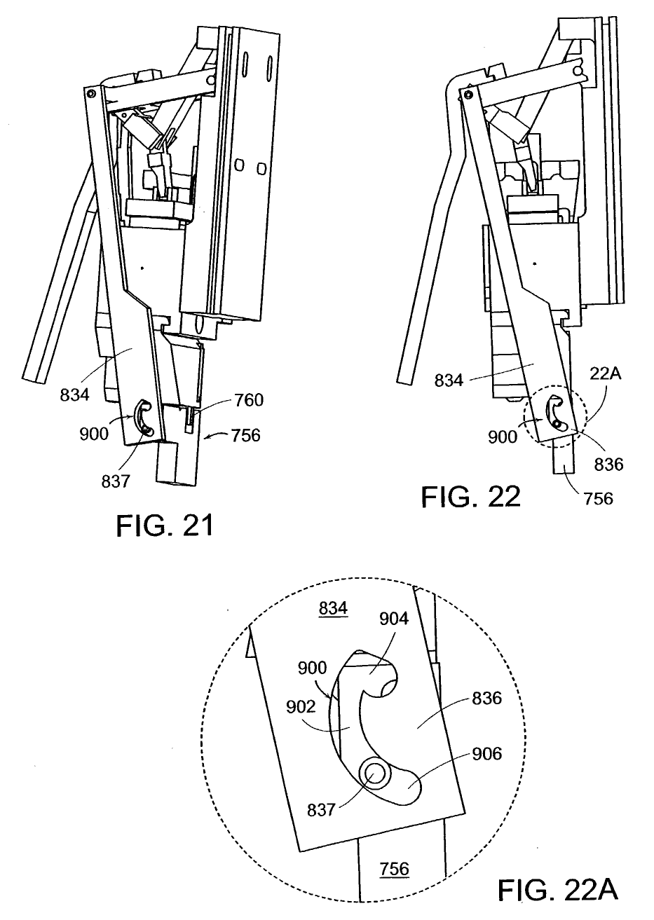

Referring to FIGS. 21-22A, wherein a second embodiment of the device 510, the lower end portion 836 of the door rod 834 comprises a cam portion 900 within which the lower end portion is moveably secured to the door 756 about the pin 837. The cam portion 900 is adapted to open the door 756 more quickly as the lever 774 is depressed. The cam portion 900 comprises an arc shaped channel 902 extending from an upper portion 904 to a lower portion 904. The door 756 is fully closed when the pin 837 is positioned at the upper portion 904. The door 756 is fully open when the pin 837 is positioned at the lower portion 904 of the cam portion 900.

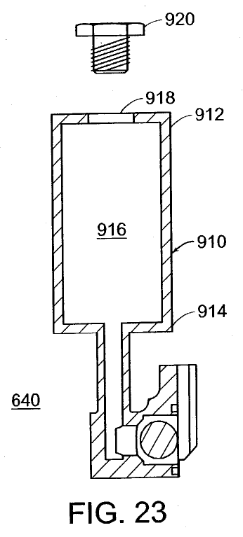

Referring to FIG. 23, where another embodiment of the device 510, a container 910 is formed as part of the intake unit 640 rather than a removable and disposable container 500 as in prior embodiments. The container 910 comprises a top portion 912, a bottom portion 914, a cavity 916, a re-fill opening 918, and a cap 920. A person may refill the container 910 by removing the cap 920 and filling the cavity 916 thru the opening 918. The container 910 is sealed close by insertion and/or engagement of the cap 920 with the opening 918.

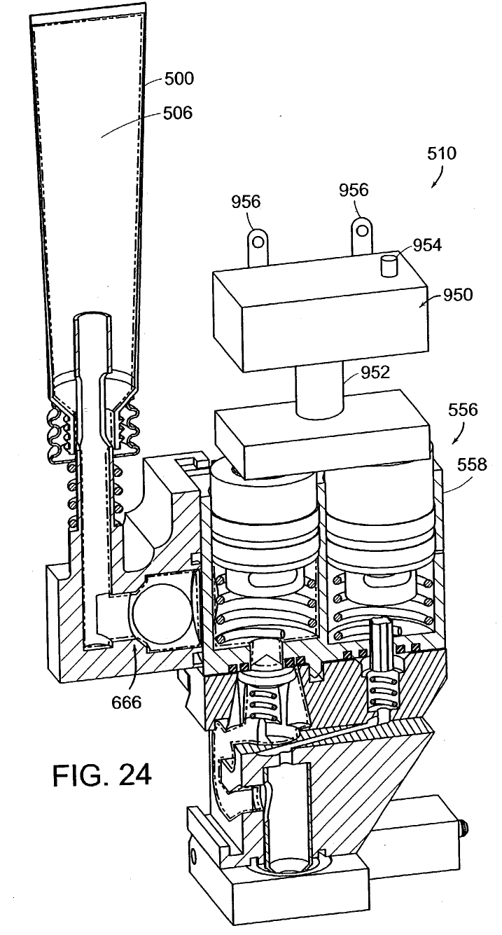

Referring to FIG. 24, wherein another embodiment of the device 510, the actuation unit 772 may comprise a solenoid 950 having a shaft 952 engaged with the medium and air piston assembly 608 and 624 and a switch 954 operable in one mode to move said medium and air piston assembly 608 and 624 through a single and complete compression and intake stroke. The solenoid 950 further comprises mounting flanges 956 to mount the solenoid 950 to the front portion 530 of the mounting plate 528. The solenoid 950 eliminates the need for the door control assembly 842.

The foregoing description is intended primarily for purposes of illustration. This invention may be embodied in other forms or carried out in other ways without departing from the spirit or scope of the invention. Modifications and variations still falling within the spirit or the scope of the invention will be readily apparent to those of skill in the art.

What is claimed:

1. A device for dispensing a medium from a container, the device comprising:
(a) a pump unit comprising medium and air pistons engaged with medium and air cylinder portions, respectively, thru a compression stroke and an intake stroke;
(b) an intake unit comprising an inlet portion engaged with the container and an outlet portion engaged with said pump unit; said intake unit further comprises an intake valve operable from a closed position to an open position where said inlet portion is in communication with said medium cylinder portion;
(c) an exhaust unit engaged with said pump unit; said exhaust unit comprises a nozzle portion; said exhaust unit further comprises an exhaust medium valve operable from a closed position to an open position where said medium cylinder portion is in communication with said nozzle portion; said exhaust unit further comprises an exhaust air valve operable from a closed position to an open position where said air cylinder portion is in communication with said nozzle portion; and
(d) an actuation unit engaged with said pump unit; activation of said actuation unit causes said medium and air pistons to move thru said compression stroke; said compression stroke of said medium piston causes a portion of the medium to enter said nozzle portion; said compression stroke of said air piston causes a portion of the air contained in said air cylinder portion to move thru said exhaust air valve to said nozzle portion whereby the medium contained in said nozzle portion is dispensed.

2. The device of claim 1, wherein said pump unit further comprises first and second springs disposed within said medium and air cylinder portions, respectively, each of said first and second springs are adapted to cause said medium and air pistons, respectively, to move thru said intake stroke; said intake stroke of said medium piston causes a portion of the medium contained in said intake unit to be drawn into said medium cylinder portion; said intake stroke of said air piston causes air to be drawn into said air cylinder portion.

3. The device of claim 2, wherein said medium cylinder portion comprises an open top portion, a medium inlet port, and a bottom portion having a medium outlet port.

4. The device of claim 3, wherein said air cylinder portion comprises an open top portion, an air inlet port, and a bottom portion having an air outlet port.

5. The device of claim 4, wherein each of said medium cylinder portion said air cylinder portion are each formed as part of said body portion.

6. The device of claim 1, wherein said inlet portion comprises an open end portion extending outward from said intake unit that is adapted to pass into the container.

7. The device of claim 6, wherein said inlet portion further comprises a cup seal disposed below said open end portion and a spring adapted to urge said cup seal in sealed engagement with the container.

8. The device of claim 7, wherein said intake unit further comprises a locking arm member adapted to prevent upward movement of the container thereby allowing said spring to urge said cup seal of said inlet portion in sealed engagement with container.

9. The device of claim 8, wherein said intake valve is a one-way check valve.

10. The device of claim 9, wherein said one-way check valve comprises a seat portion and a ball.

11. The device of claim 10, wherein said intake valve is open and closed when said ball is disengaged and engaged with said seat portion, respectively.

12. The device of claim 1, wherein said exhaust unity further comprises a body portion, a medium cavity portion, and an air cavity portion.

13. The device of claim 12, wherein said medium cavity comprises an open top portion and an open bottom portion.

14. The device of claim 13, wherein said air cavity comprises an open top portion and an open bottom portion.

15. The device of claim 14, wherein said medium cavity and said air cavity are each formed as part of said body portion of said exhaust unit.

16. The device of claim 15, wherein said exhaust unit further comprises a door member engaged with said body portion and adapted to open and expose said nozzle portion during said compression stroke and close and enclose said nozzle portion during said intake stroke.

17. The device of claim 16, wherein said exhaust medium valve is a one-way spring valve.

18. The device of claim 17, wherein said exhaust air valve is a pop-off spring valve.

19. The device of claim 1, wherein said actuation unit further comprises a lever member and linkage assembly; said linkage assembly being engaged with said medium and air pistons and said lever member; downward movement of said lever member causes said medium and air pistons to move thru said compression stroke.

20. The device of claim 1, wherein said actuation unit comprises an motor unit engaged with said medium and air pistons and a switch operable to move said medium and air pistons through said compression and intake strokes.

21. The device of claim 1, further comprising a door control assembly adapted to prevent the lever member from moving upward until said compression stroke is completed whereupon said lever member is released and said intake stroke begins.
